(19) United States
(12) Patent Application Publication
(10) Pub. No.: US 2020/0386358 A1
(43) Pub. Date: Dec. 10, 2020

(54) FLUID-BEARING PIPE FITTINGS ENHANCING FLUID DELIVERY SYSTEM PERFORMANCE

(71) Applicant: FHE USA LLC, Fruita, CO (US)

(72) Inventors: Matthew E. Kibler, Grand Junction, CO (US); Kyle Scholl, Dunlap, IL (US); Nicolas G. Snoke, Grand Junction, CO (US)

(21) Appl. No.: 16/898,135

(22) Filed: Jun. 10, 2020

Related U.S. Application Data
(60) Provisional application No. 62/859,255, filed on Jun. 10, 2019.
(60) Provisional application No. 63/036,726, filed on Jun. 9, 2020.

(51) Int. Cl. F16L 43/00; E21B 43/26; E21B 33/047

(52) U.S. Cl. CPC F16L 43/00; E21B 33/047; E21B 43/2607

(57) ABSTRACT

An elbow fitting including an inlet and an outlet. An internal flow path and an internal enclosed portion are formed within the elbow body such that the inlet is in fluid communication with the outlet via the flow path. The enclosed portion generally opposes the inlet and is in fluid communication with the flow path. The elbow fitting may be a casting or a forging. The inlet may have an internal diameter of not less than about 7 inches, and the elbow body may be further capable of retaining an internal pressure of not less than about 10,000 psi. The flow path may further include an enlarged chamber also formed within the elbow body. The enlarged chamber may be generally spherically shaped. In such designs, the enclosed portion is in fluid communication with the enlarged chamber.

### RELATED APPLICATIONS AND PRIORITY CLAIMS

This application claims the benefit of, and priority to, the following co-pending, commonly-invented and commonly-assigned U.S. provisional patent applications: (1) Ser. No. 62/859,255 filed Jun. 10, 2019; and (2) Ser. No. 63/036,726 filed Jun. 9, 2020. The entire disclosures of 62/859,255 and 63/036,726 are incorporated herein by reference. This application is further related to commonly-invented and commonly-assigned U.S. Nonprovisional patent application Ser. No. 16/406,927, filed May 8, 2019 (now U.S. Pat. No. 10,466,719) (the “Related Application”). The Related Application's entire disclosure is also incorporated herein by reference.

### FIELD OF THE DISCLOSURE

This disclosure relates to the field of pipe fittings for fluid delivery systems, advantageously at high volumes and pressures. Embodiments of fittings described in this disclosure may be deployed, for example, in fracturing fluid (“fracking”) operations during subterranean drilling for hydrocarbons.

### BACKGROUND

In some oil and gas exploration embodiments, high-pressure and high-volume fluid delivery systems are configured to deliver fluid from surface-deployed equipment to wells drilled through subsurface formations. The Related Application describes examples of such fluid delivery systems.

High pressure, high volume fluid delivery systems are particularly suitable for fracking operations in oil and gas exploration. This disclosure describes improvements to fluid-bearing fittings suitable for exemplary use in fracking fluid delivery systems (although the described improvements are not limited to fracking deployments or embodiments). The described improvements enhance the overall performance of the fluid-bearing fittings, thereby also enhancing the overall performance of the fluid delivery systems on which the improved fittings may be deployed.

The Related Application describes embodiments of fluid delivery systems suitable for fracking service. The fluid delivery system embodiments described in the Related Application are disclosed with conventional generic swept elbow fittings. Improved fluid-bearing pipe fittings such as described in this disclosure may be deployed on fluid delivery system embodiments described in the Related Application, and may thereby enhance the fluid delivery performance of such described systems.

Fracking operations may call for fracking fluid to be delivered to the well head at a pressure preferably of at least about 7,500 psi, and more preferably of at least about 10,000 psi, and yet more preferably of at least about 15,000 psi. In some fracking operations, fracking fluid may be required to be delivered to the well head at a pressure of at least about 20,000 psi. Fluid-bearing delivery piping and fluid-bearing fittings must therefore be rated for such internal pressures. Fracking operations may further call for fracking fluid to be delivered at volumes mandating a flow rate preferably of at least about 70 bbl/min (about 49 gal/sec), and more preferably of about 115 bbl/min (about 80.5 gal/sec), and in some cases over 130 bbl/min (about 91 gal/sec). Such flow rates in turn may require fluid-bearing delivery piping and fluid-bearing fittings to have an internal diameter of about 7″ or about 8″ in order to deliver fluid at the required flow rate at the operating pressures described above. Fracking fluid may flow at speeds in excess of about 40 feet/sec (about 27 mph) in deployments having a nominal flow pipe internal diameter of about 7″-8″ and a nominal flow rate of about 115 bbl/min.

It is also well understood that different types of subterranean fracturing operations may call for different types of fracking fluids. Some fracking fluids may contain suspended solids (“proppant”). The solids may make the fracking fluid abrasive (and in some cases, highly abrasive) to the internal walls of fluid-bearing piping and fluid-bearing fittings, particularly when the fluid is delivered at the flow rates discussed immediately above. Other known fracking fluids may contain chemical ingredients that may be corrosive to the fluid-bearing piping and fluid-bearing fittings through which the fluids may pass.

FIGS. 1A and 1B illustrate a typical prior art elbow fitting 100 suitable for use in fracking operations. FIG. 1A depicts prior art elbow 100 in perspective view, and FIG. 1B is a section as shown on FIG. 1A. While prior art elbow fitting 100 as depicted on FIGS. 1A and 1B generally functions as an elbow, it will be appreciated that prior art elbow 100 is derived from a “tee” fitting. The base of the tee is used as an outlet, one of the laterals of the tee is used as an inlet, and the other lateral of the tee is sealed off with a cover. Suitable embodiments of prior art elbow 100 are currently available from RBV Energy, Ltd. of Newcastle upon Tyne, U.K.

FIG. 1A illustrates prior art elbow 100 as being of a generally cube design, with inlet 101A and outlet 101B. Holes 102 are provided around each of inlet and outlet 101A, 101B to receive threaded fasteners such as bolts when attaching flanged fittings or piping. Cover 103 provides access to the inside of elbow 100.

FIG. 1B shows that elbow 100 further provides a generally tee-shaped internal cavity 106. Internal cavity 106 includes four portions: inlet 101A portion, outlet 101B portion, flow path portion 104 and cavity portion 105.

There are several attractions to using the generally cube-shaped style of prior art elbow fitting 100 exemplified on FIGS. 1A and 1B. The tee-derived design is robust, simple to manufacture, and will readily withstand the internal pressures demanded by fracking fluid service. Many designs exemplified by FIGS. 1A and 1B may be manufactured from a solid block of metal by drilling and reaming (for example) to provide inlet 101A portion, outlet 101B portion, flow path portion 104 and cavity portion 105. Further, cavity portion 105 (as shown on FIG. 1B) creates a pocket of slow-moving fluid during fluid flow. When the fluid has non-Newtonian properties (as described in more detail below), fast-moving fluid passing from inlet 101A to outlet 101B through flow path portion 104 may deviate or “bounce” off slow-moving fluid in cavity portion 105, thereby encouraging flow deflection “around the corner” from inlet 101A to outlet 101B.

There are also significant disadvantages of using the style of prior art elbow fitting 100 exemplified on FIGS. 1A and 1B. They tend to be bulky and heavy. In one embodiment, a 7″ internal diameter elbow fitting in the style of prior art elbow 100 weighs in excess of 2,200 lbs. Accumulation of cantilevered weight is a significant design and performance concern in boom-style fluid delivery systems such as are described in the Related Application.

Further, the flow path mandated by the style of prior art elbow fitting 100 causes discernable loss of fluid flow velocity as fluid is forced to “turn the corner” from inlet 101A to outlet 101B. This loss of fluid flow velocity occurs even when the fluid has non-Newtonian properties, when fast-moving flow may take advantage of “bouncing” off slow-moving fluid in cavity portion 105 as it “turns the corner”.

The fluid's non-Newtonian properties may arise by virtue of the fracking fluid having solids suspended therein. Alternatively, or additionally, the non-Newtonian properties may be inherent to constituent fluids in the base fracking fluid (in which solids may or may not be suspended).

By way of background, Newtonian fluids, such as water, typically have predictable changes in viscosity according to corresponding changes in pressure or temperature. They exhibit little to no change in viscosity, however, in response to the size of a force exerted on the fluid. In contrast, non-Newtonian fluids, such as some fracking fluids, have viscosities that vary not only in accordance with pressure or temperature, but also with the size of the force that may be exerted on the fluid. Some non-Newtonian fluids exhibit higher viscosities when larger forces are applied to them. Non-Newtonian fracking fluids fall almost universally into this category. (Other non-Newtonian fluids are known to become less viscous the larger the force applied.) Thus, in the case of non-Newtonian fracking fluids, for example, if an object (e.g. a cylindrical object) is inserted into the fluid with varying force, the fluid will exhibit greater viscosity according to the force with which the object is inserted. The fluid will thus offer greater resistance to penetration by the object according to the force with which the object is inserted. The degree of resistance will depend on multiple factors, including temperature and pressure of the fluid. However, all other parameters being equal, the fluid will increasingly resist penetration by the same object as the object is inserted with increasing force.

Referring now to flow of non-Newtonian fracking fluids through prior art elbow fitting designs such as illustrated on FIGS. 1A and 1B as described above, such fracking fluids may travel at high velocities within a pipe during fracking operations. As flow enters prior art elbow 100 through inlet 101A, fast-moving fluids may exert high forces against pockets of slow-moving fluid encountered, for example, in cavity portion 105 on FIG. 1B when the fast-moving flow is forced to “turn the corner” towards outlet 101B. In such encounters, the pockets of slow-moving fluid in cavity portion 105 may become very viscous in response to the high forces exerted by the fast-moving flow, such that the slow-moving flow resists penetration or commingling by the fast-moving flow. As a result, the fast-moving flow tends to deviate or “bounce” off the slow-moving flow and become redirected towards outlet 101B.

However, as noted above, notwithstanding the “bounce” effect offered by some non-Newtonian fluids in some deployments, the style of prior art elbow fitting 100 exemplified on FIGS. 1A and 1B still causes discernable loss of fluid flow as fluid is forced to “turn the corner” from inlet 101A to outlet 101B. The loss of fluid flow is illustrated on FIG. 1D of U.S. provisional patent application Ser. No. 62/859,255 filed Jun. 10, 2019, to which this application claims priority and whose entire provisional disclosure is incorporated herein by reference. FIG. 1D of 62/859,255 (“62/859,255—1D”) is a fluid flow diagram of prior art elbow fitting 100 on FIGS. 1A and 1B, colorized to show flow rates of fluid as fluid passes from inlet 101A to outlet 101B along flow path portion 104. 62/859,255—1D assumes non-Newtonian fracking fluid. A pocket of slow-moving (non-Newtonian) fluid has accumulated in cavity portion 105. The pocket of slow-moving fluid in cavity portion 105 is moving in a spiral, where the fluid in the center of the spiral is almost at a standstill.

62/859,255—1D shows that fluid entering through inlet 101A slows significantly at the turn toward outlet 101B. Flow slows almost to a standstill on the inside of the turn. Fast-moving flow on the outside of the turn deviates or “bounces” off slow-moving flow in cavity portion 105 and heads towards outlet 101B. Even in the presence of the “bounce”, however, flow leaving through outlet 101B is overall much slower than flow entering through inlet 101A.

Loss of flow rate such as illustrated on 62/859,255—1D accumulates in fluid delivery systems where multiple prior art elbows 100 are provided in sequence. Refer, for example, to the fluid delivery system embodiments described in the Related Application, in which multiple elbows are required in sequence to deliver fluid from a surface-deployed source to a well head. It will be appreciated that the disadvantage of loss of flow rate in a single prior art elbow 100 is magnified when a deployment requires multiple sequential elbows. The loss of flow rate is correspondingly magnified.

Other prior art elbow fittings have attempted to address the loss of flow rate exemplified by 62/859,255—1D on the prior art elbow fitting 100 design of FIGS. 1A and 1B of this disclosure. See, for example, U.S. Pat. No. 4,387,914 to Paulson (“the '914 patent”). FIGS. 2A and 2B of 62/859,255 (“62/859,255—2A and —2B”) disclosure illustrate prior art elbow fitting 200, a commercial embodiment of the '914 patent available from the HammerTek Corporation of Bethlehem, Pa., U.S.A. As shown on 62/859,255—2A and —2B, prior art elbow 200 provides inlet and outlet 201A, 201B and an inside turn curvature 210. The interior of prior art elbow further provides flow path portion 204 and cavity portion 205. The '914 patent seeks to improve on conventional swept elbows, such as are shown on FIG. 1 of the '914 patent and on embodiments of fluid delivery systems described in the Related Application. The improvement sought seeks to tighten the turn made between inlet and outlet, reducing overall size and weight, and further reducing loss of flow velocity as fluid and particles “turn the corner”. The '914 patent does not discuss whether the fluid flowing within prior art elbow 200 is a Newtonian fluid or a non-Newtonian fluid. With reference to 62/859,255—2A and —2B, and adapting from col. 2, lines 40-48 of the '914 patent, the theory of operation of prior art elbow 200 is that a self-forming target zone in cavity portion 205 deflects particles towards outlet 201B which eliminates wear of the elbow 200 and loss of velocity from friction against the interior wall and from centrifugal force as the fluid and particles “turn the corner”. A continuously replenishing supply of material forms a slowly revolving vortex in cavity portion 205 providing a soft impact zone on which flow of fluid and particles deviates (or “bounces”). The deflected particles are quickly returned to the conveying velocity with the minimum loss of energy. As a result, embodiments such as prior art elbow 200 described in the '914 patent may have a tighter inside turn curvature 210 than conventional swept elbows. Loss of flow velocity is also optimized over conventional swept elbows.

The prior art elbow 200 design of 62/859,255—2A and —2B is a relatively low pressure, low flow rate design, and thus has limited application to high pressure, high volume fluid delivery deployments. Embodiments of prior art elbow 200 art are generally not suitable for fracking fluid delivery service given the high pressure, high volume delivery requirement. Further, embodiments of prior art elbow 200 generally exhibit poor resistance to internal abrasion when exposed to the high flow rates typically associated with fracking fluid delivery service. Nonetheless, the inside turn curvature 210 feature on 62/859,255—2A and —2B may have application in modifying the prior art elbow fitting 100 design of FIGS. 1A and 1B of this disclosure for improved flow rate and flow distribution.

There is therefore a need in the art for improvements to fluid-bearing fittings, advantageously at high pressures and flow rates in order to deliver fluid at high volumes at such pressures. Such improvements will advantageously enhance the overall performance of fluid delivery systems on which such fluid-bearing fittings are deployed, such performance enhancements including fluid flow rate capability, wear resistance, and weight reduction in (for example) cantilevered boom deployments such as described in the Related Application. Embodiments of such fluid-bearing fittings improvements will be particularly suited to optimize fluid delivery in high-pressure, high-volume fracking operations.

### SUMMARY AND TECHNICAL ADVANTAGES

This disclosure describes elbow fitting designs engineered and proven to provide serviceable fluid delivery volumes and internal pressure ratings to be suitable for fracking operations. Preferred embodiments have an internal diameter at inlet (nominal diameter) of not less than about 7 inches, and are further rated to retain an internal pressure of not less than about 10,000 psi.

The described elbow fitting designs are further engineered to weigh less than prior art counterparts, thereby making them suitable to be deployed on cantilevered fluid delivery systems such as disclosed in the Related Application.

Embodiments of the disclosed elbow fittings designs may be forgings or castings, for example. The scope of this disclosure is not limited to the metalworking process by which the elbow fittings are manufactured. Forging embodiments preferably provide an enlarged chamber (and more preferably, a spherically shaped enlarged chamber) in the flow path between inlet and outlet. The spherically shaped enlarged chamber provides a local pocket of increased fluid volume within the elbow fitting, causing corresponding slower fluid flow velocity within and through the enlarged chamber. The slower fluid flow velocity reduces the potential for fluid flow erosion within the enlarged chamber.

Casting embodiments preferably provide inside turn curvatures engineered to allow allows fast-moving solids and fluids to move from inlet to outlet while optimizing loss of flow velocity as fluid “turns the corner”. Specific inside turn curvatures are customized according to design requirements of a particular elbow fitting. Parameters such as internal fluid pressure retention, fluid flow velocity, fluid flow volume, acceptable internal wear and fitting weight may be taken into account in designing specific inside turn curvatures in view of the chemistry and solids content of the fluid to be delivered.

Described elbow fitting embodiments may also provide additional internal wear protection.

Described elbow fitting embodiments may also provide wall thickness enhancement in selected regions of the elbow body. Techniques such as Finite Element Analysis (FEA) may show regions of the elbow may become susceptible to tensile stresses approaching yield stress at rated internal pressures. Embodiment of the disclosed elbow fittings enhance the wall thickness in such regions, thereby reducing local tensile stresses while still keeping overall fitting weight low.

It is therefore a technical advantage of the disclosed elbow fittings to deliver fluid volumes and to withstand internal pressures according to the needs of fracking service.

A further technical advantage of the disclosed elbow fittings is that they are designed to optimize loss of fluid flow velocity as fluid “turns the corner”. As a result, the disclosed elbow fittings deliver high volumetric throughput. Embodiments provide internal geometric shapes in the flow path that promote smooth fluid flow and sustained flow velocity through the elbow fitting. Embodiments also “bounce” faster-moving fluid “round the corner” of the elbow off pockets of slower-moving fluids within the elbow. This “bounce” further promotes smooth fluid flow and sustained flow velocity through the fitting.

A further technical advantage of the disclosed elbow fittings is that their weight is optimized. The elbow fittings are thus suitable for cantilevered fluid delivery systems such as disclosed in the Related Application.

A further technical advantage of the disclosed elbow fittings is that they are designed for reduced internal wear and erosion. Lower susceptibility to wear and erosion in turn promotes longer service life and overall cost effectiveness.

In accordance with a first aspect, therefore, this disclosure describes embodiments of an elbow fitting, comprising: an elbow body, the elbow body having an inlet, an outlet and an internal flow path formed therein such that the inlet is in fluid communication with the outlet via the flow path, wherein the flow path subtends a predetermined turn angle between the inlet and the outlet; wherein the flow path further includes an enlarged chamber also formed within the elbow body.

In some embodiments according to the first aspect, the elbow body further includes an internal enclosed portion formed therein such that the enclosed portion is in fluid communication with the enlarged chamber and wherein the enclosed portion generally opposes the inlet.

In some embodiments according to the first aspect, the enlarged chamber is generally spherically shaped.

In some embodiments according to the first aspect, the predetermined turn angle is 90 degrees.

In some embodiments according to the first aspect, when fluid is caused to flow along the flow path from the inlet to the outlet and enters the enlarged chamber flowing at a first fluid velocity, fluid flows through the enlarged chamber towards the outlet at a second fluid velocity such that the second fluid velocity is less than the first fluid velocity. In other embodiments, a pocket of slow-moving fluid forms in the enclosed portion as fluid flows through the enlarged chamber; and the slow-moving fluid in the enclosed portion flows at less than the second fluid velocity.

In some embodiments according to the first aspect, the elbow fitting further includes a removable cover, and in which the enclosed portion is enclosed at least in part by the removable cover.

In some embodiments according to the first aspect, the elbow fitting further comprises wall thickness enhancement in selected regions of the elbow body.

In some embodiments according to the first aspect, the elbow fitting further comprises a wear insert.

In some embodiments according to the first aspect, the elbow fitting is selected from the group consisting of (a) a forging, and (b) a casting.

In some embodiments according to the first aspect, the inlet has an internal diameter of not less than about 7 inches, and in which the elbow body is further capable of retaining an internal pressure of not less than about 10,000 psi.

In accordance with a second aspect, this disclosure describes embodiments of an elbow fitting, comprising: an elbow body, the elbow body having an inlet and an outlet, the elbow body further having an internal flow path and an internal enclosed portion formed therein such that the inlet is in fluid communication with the outlet via the flow path, wherein the flow path subtends a predetermined turn angle between the inlet and the outlet; wherein the flow path further includes an enlarged chamber also formed within the elbow body; wherein the enclosed portion is in fluid communication with the enlarged chamber and wherein the enclosed portion generally opposes the inlet.

In some embodiments according to the second aspect, the enlarged chamber is generally spherically shaped.

In some embodiments according to the second aspect, the predetermined turn angle is 90 degrees.

In some embodiments according to the second aspect, when fluid is caused to flow along the flow path from the inlet to the outlet and enters the enlarged chamber flowing at a first fluid velocity, fluid flows through the enlarged chamber towards the outlet at a second fluid velocity such that the second fluid velocity is less than the first fluid velocity. In other embodiments, a pocket of slow-moving fluid forms in the enclosed portion as fluid flows through the enlarged chamber; and the slow-moving fluid in the enclosed portion flows at less than the second fluid velocity.

In some embodiments according to the second aspect, the elbow fitting further includes a removable cover, and in which the enclosed portion is enclosed at least in part by the removable cover

In some embodiments according to the second aspect, the elbow fitting further comprises wall thickness enhancement in selected regions of the elbow body.

In some embodiments according to the second aspect, the elbow fitting further comprises a wear insert.

In some embodiments according to the second aspect, the elbow fitting is selected from the group consisting of (a) a forging, and (b) a casting.

In some embodiments according to the second aspect, the inlet has an internal diameter of not less than about 7 inches, and in which the elbow body is further capable of retaining an internal pressure of not less than about 10,000 psi.

In accordance with a third aspect, this disclosure describes embodiments of an elbow fitting, comprising: an elbow body, the elbow body having an inlet and an outlet, the elbow body further having an internal flow path and an internal enclosed portion formed therein such that the inlet is in fluid communication with the outlet via the flow path, wherein the flow path subtends a predetermined turn angle between the inlet and the outlet; wherein the flow path further includes an enlarged chamber also formed within the elbow body in which the enlarged chamber is generally spherically shaped; wherein the enclosed portion is in fluid communication with the enlarged chamber and wherein the enclosed portion generally opposes the inlet.

In some embodiments according to the third aspect, the predetermined turn angle is 90 degrees.

In some embodiments according to the third aspect, when fluid is caused to flow along the flow path from the inlet to the outlet and enters the enlarged chamber flowing at a first fluid velocity, fluid flows through the enlarged chamber towards the outlet at a second fluid velocity such that the second fluid velocity is less than the first fluid velocity. In other embodiments, a pocket of slow-moving fluid forms in the enclosed portion as fluid flows through the enlarged chamber; and the slow-moving fluid in the enclosed portion flows at less than the second fluid velocity.

In some embodiments according to the third aspect, the elbow fitting further includes a removable cover, and in which the enclosed portion is enclosed at least in part by the removable cover.

In some embodiments according to the third aspect, the elbow fitting further comprises wall thickness enhancement in selected regions of the elbow body.

In some embodiments according to the third aspect, the elbow fitting further comprises a wear insert.

In some embodiments according to the third aspect, the elbow fitting is selected from the group consisting of (a) a forging, and (b) a casting.

In some embodiments according to the third aspect, the inlet has an internal diameter of not less than about 7 inches, and in which the elbow body is further capable of retaining an internal pressure of not less than about 10,000 psi.

The foregoing has outlined rather broadly some of the features and technical advantages of the technology embodied in the disclosed fluid-bearing pipe fittings technology, in order that the detailed description that follows may be better understood. Additional features and advantages of the disclosed technology may be described. It should be appreciated by those skilled in the art that the conception and the specific embodiments disclosed may be readily utilized as a basis for modifying or designing other structures for carrying out the same inventive purposes of the disclosed technology, and that these equivalent constructions do not depart from the spirit and scope of the technology whose exemplary embodiments are recited in the appended claims.

### BRIEF DESCRIPTION OF THE DRAWINGS

For a more complete understanding of embodiments described in detail below, and the advantages thereof, reference is now made to the following drawings, in which:

FIG. 1A illustrates a prior art elbow fitting 100;

FIG. 1B is a section as shown on FIG. 1B;

FIG. 2A illustrates an exemplary fluid delivery system (FDU) 1100 on which embodiments of fluid-bearing pipe fittings described in this disclosure may be deployed:

FIG. 2B illustrates embodiments of connected fluid flow pipe and fittings within an inset depicted on FIG. 2A;

FIG. 3A is a general illustration of improved elbow fitting 300 as described in this disclosure:

FIG. 3B is a section as shown on FIG. 3A;

FIG. 3C is a section as shown on FIG. 3A;

FIG. 3D is a section as shown on FIG. 3A;

FIG. 4A is a general illustration of improved elbow fitting 400 as described in this disclosure;

FIG. 4B is an elevation view of elbow fitting 400;

FIG. 4C is a section as shown on FIG. 4A;

FIG. 4D is a section as shown on FIG. 4B;

FIG. 4E is a section as shown on FIG. 4B; and

FIG. 5 illustrates improved non-90 degree elbow fitting 350 in section, with wear insert 600 attached internally.

### DETAILED DESCRIPTION

The following description of embodiments provides non-limiting representative examples using Figures and schematics with part numbers and other notation to describe features and teachings of different aspects of the disclosed technology in more detail. The embodiments described should be recognized as capable of implementation separately, or in combination, with other embodiments from the description of the embodiments. A person of ordinary skill in the art reviewing the description of embodiments will be capable of learning and understanding the different described aspects of the technology. The description of embodiments should facilitate understanding of the technology to such an extent that other implementations and embodiments, although not specifically covered but within the understanding of a person of skill in the art having read the description of embodiments, would be understood to be consistent with an application of the disclosed technology.

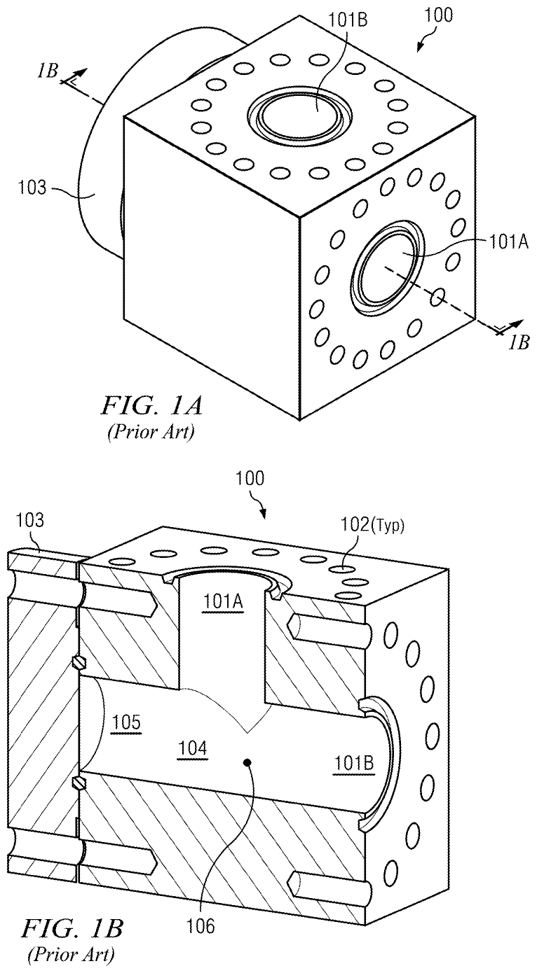

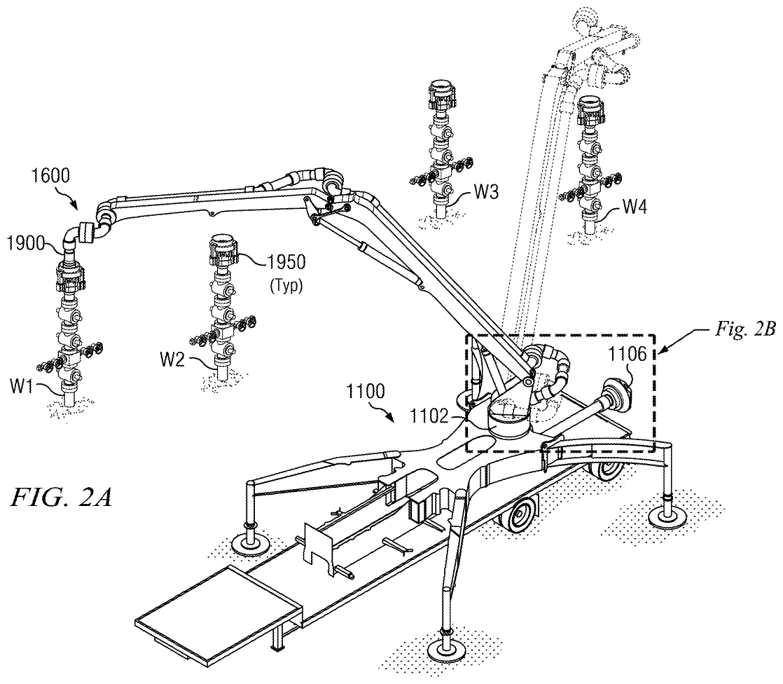

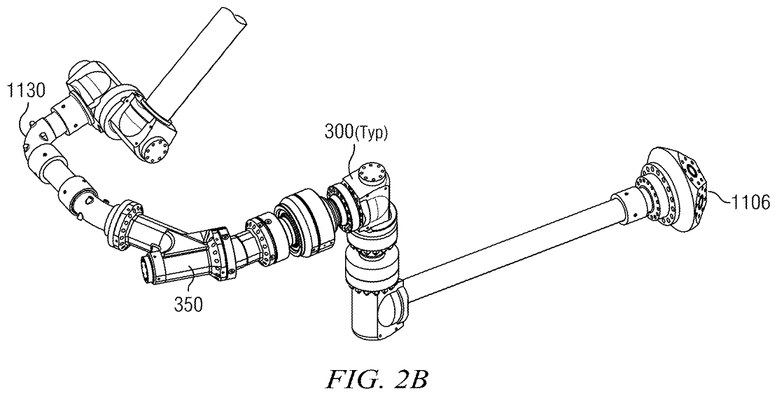

FIGS. 1A and 1B of this disclosure, and FIGS. 2A and 2B of 62/859,255 (the entire disclosure of which provisional application is incorporated herein by reference) illustrate examples of the prior art on which the disclosed technology seeks to improve. FIGS. 1A and 1B of this disclosure, and FIGS. 62/859,255—2A and —2B are discussed in detail above in the “Background” section.

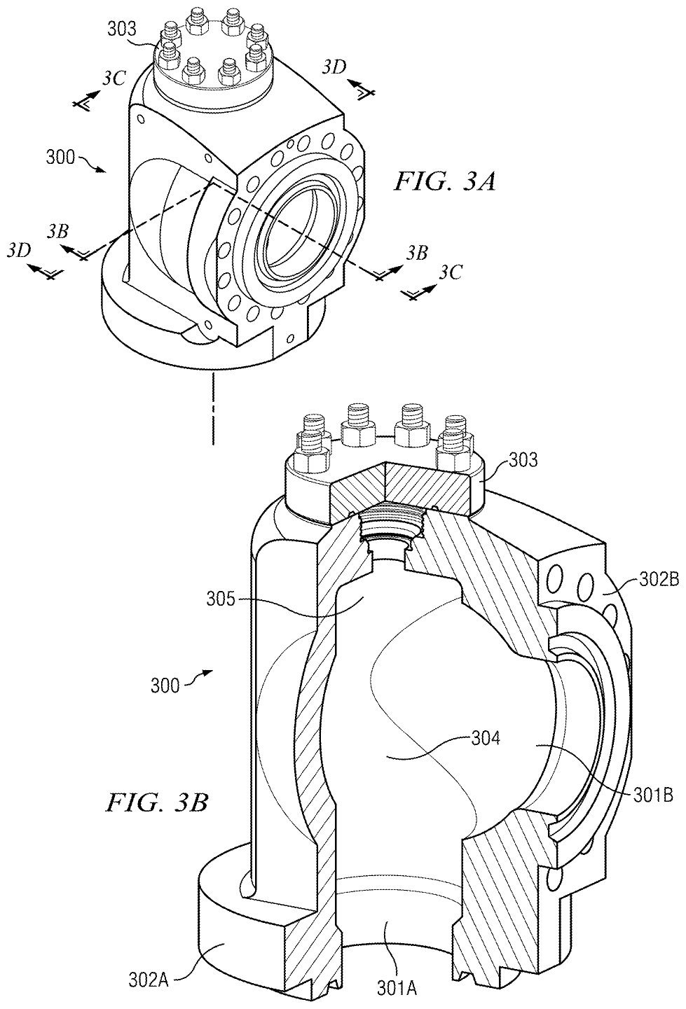

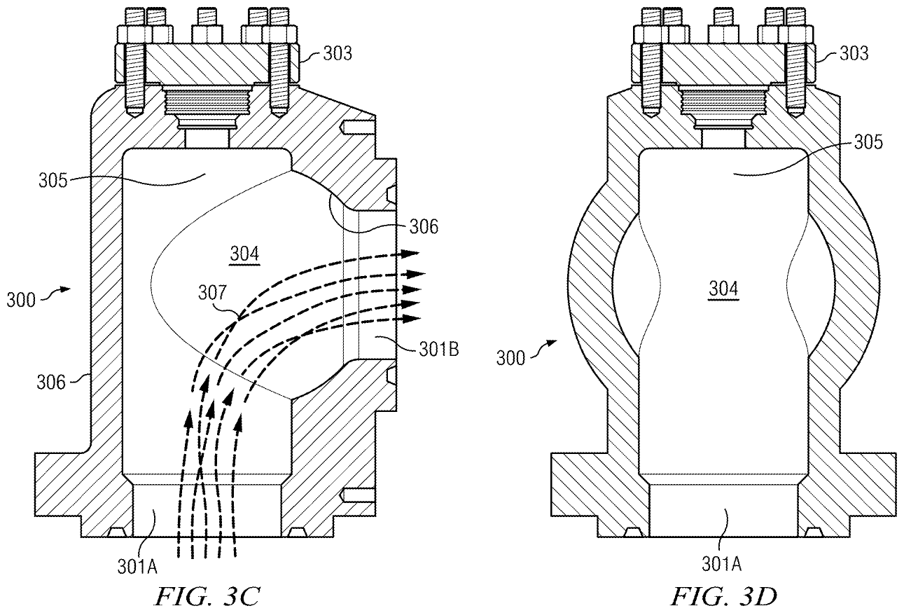

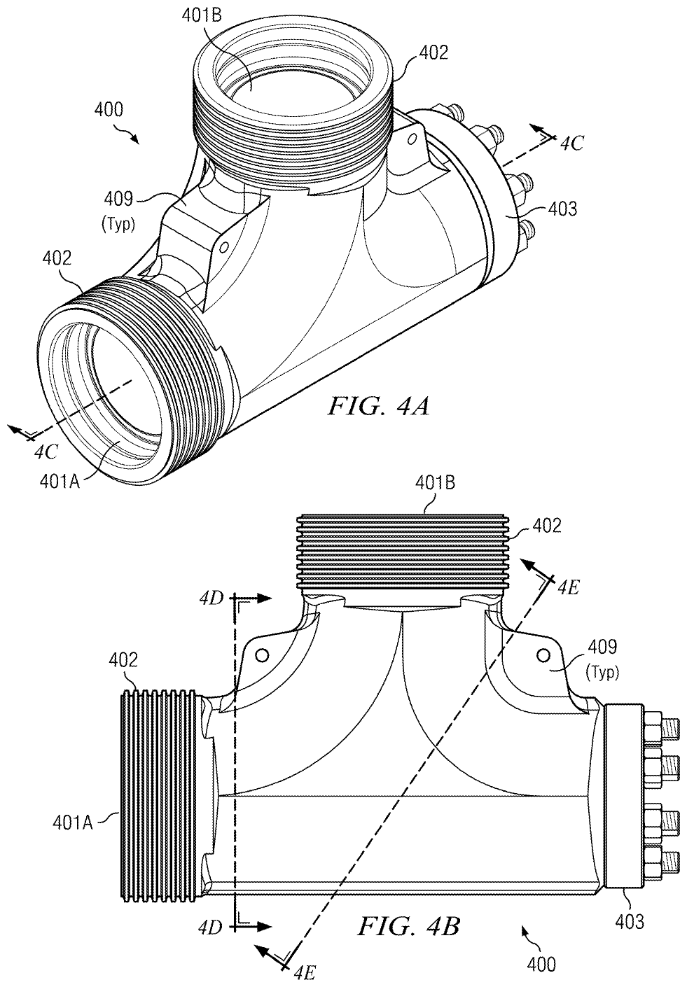

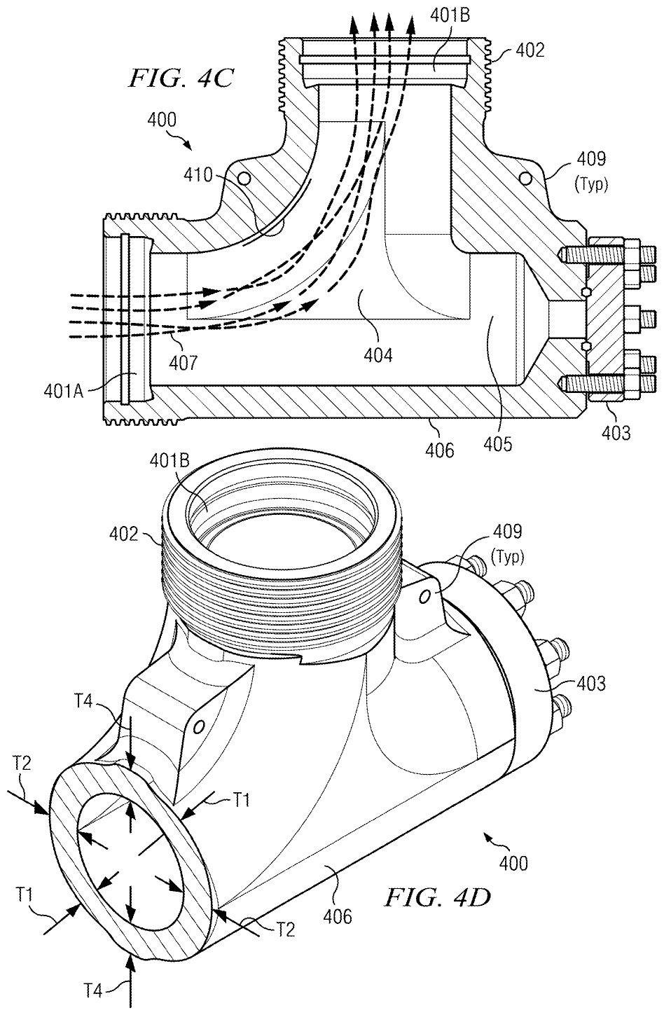

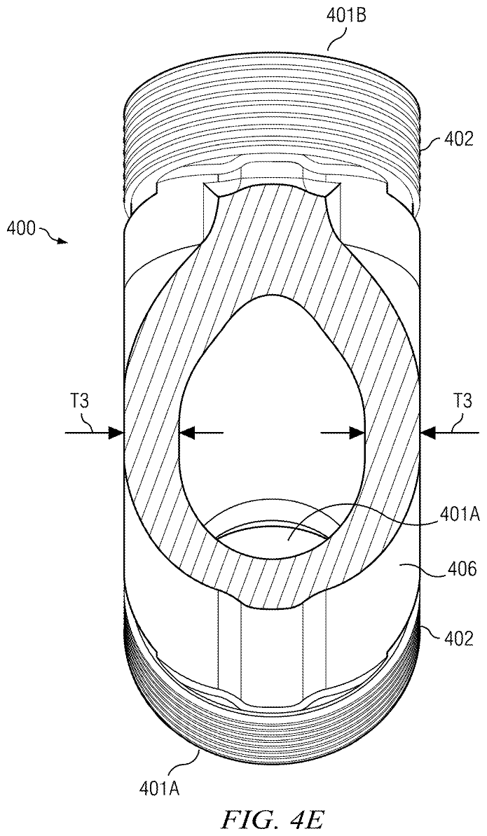

FIGS. 2A and 2B of this disclosure illustrate an exemplary fracking fluid delivery system on which embodiments of fluid-bearing pipe fittings described in this disclosure may advantageously be deployed. FIG. 2A is based on FIG. 4 of the Related Application (U.S. nonprovisional patent application Ser. No. 16/406,927 filed May 8, 2019). FIG. 2B illustrates embodiments of connected pipe and fittings within an inset depicted on FIG. 2A. FIGS. 3A through 5 of this disclosure illustrate currently preferred embodiments of the disclosed improvements of fluid-bearing fittings.

FIGS. 2A through 5 should be viewed together for purposes of this disclosure. Any part, item, or feature that is identified by part number on one of FIGS. 2A through 5 will have the same part number when illustrated on another of FIGS. 2A through 5. It will be understood that the embodiments as illustrated and described with respect to FIGS. 2A through 5 are exemplary only and serve to illustrate the larger concept of the technology. The inventive material set forth in this disclosure is not limited to such illustrated and described embodiments.

As noted, FIG. 2A is based on FIG. 4 of the Related Application. FIG. 2A illustrates an embodiment of a Fluid Delivery Unit (FDU) 1100 deployed on an exemplary jobsite to deliver fluid (such as fracking fluid) to selected wellheads W1 through W4 within reach of FDU 1100. FDU 1100 includes rotating base turret 1102 which, as may be seen on FIG. 2A, enables FDU 1100 to deliver fluid anywhere within range on a 360-degree rotation of turret 1102.

FIG. 2A further shows FDU 1100 disposed to receive fluid via FDU fluid inlet 1106. In some embodiments, FDU fluid inlet 1106 may be of the manifold style commonly referred to as a “goat head” in oilfield fracking and well completion operations, with a hollow body providing multiple connection points (e.g. flange faces) to connect to individual fluid transfer lines.

FIG. 2A further illustrates FDU 1100 providing stinger assembly 1600 at a distal delivery end thereof. In preferred embodiments, stinger assembly 1600 includes fluid connection adapter 1900. Each wellhead W1 through W4 on FIG. 2A is disposed to receive fluid via a fluid connection housing assembly 1950 connected to the top thereof. Fluid connection housing assemblies 1950 are advantageously alike in that fluid connection adapter 1900 on stinger assembly 1600 is configured to be received and locked into any one of a desired fluid connection housing assembly 1950 prior to delivery of fluid to a corresponding wellhead W1 through W4.

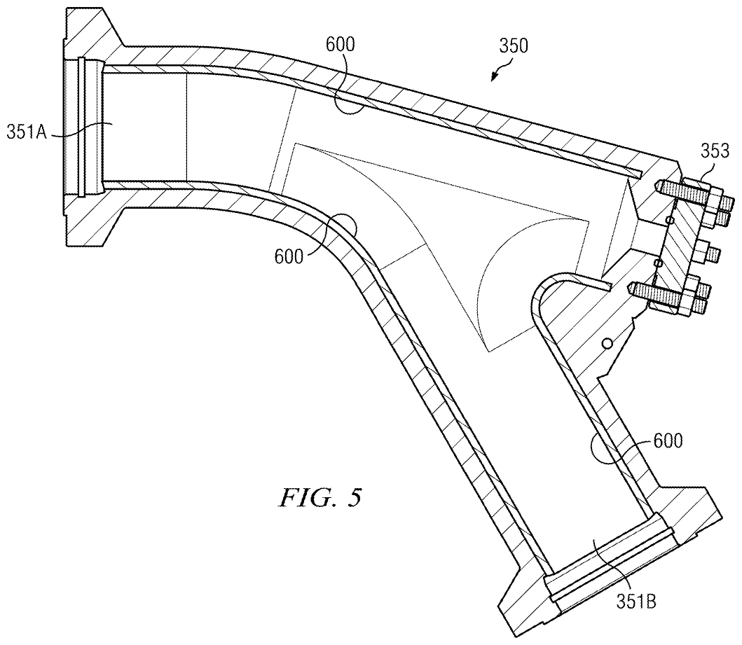

FIG. 2B illustrates embodiments of connected fluid flow pipe and fittings (colloquially, “flow iron”) on FDU 1100 within an inset shown on FIG. 2A. FIG. 2B depicts the flow iron in isolation. FIG. 2B shows FDU fluid inlet 1106 as described above in more detail with reference to FIG. 2A. FIG. 2B further illustrates elbow fittings 300 and non-90 degree elbow fitting 350 included in the flow iron. Elbow fittings 300 on FIG. 2B are as illustrated and described in this disclosure with reference to FIGS. 3A through 3D, and as discussed below with further reference to U.S. provisional patent application Ser. No. 63/036,726 (the entire disclosure of which provisional application is incorporated herein by reference). Non-90 degree elbow fitting 350 is as discussed below with reference to FIG. 5 and U.S. provisional patent application Ser. No. 62/859,255 (the entire disclosure of which provisional application is also incorporated herein by reference). Alternatively, although not illustrated, FDU 1100 may provide elbow fittings 400 as illustrated and described in this disclosure with reference to FIGS. 4A through 4E and U.S. provisional patent application 62/859,255.

FIG. 2B also illustrates a conventional elbow 1130 to signify that embodiments of FDU 1100 are not limited to particular or specific flow iron fittings. FDU 1100's flow iron may include one or more of elbow fittings 300, 350 as illustrated, or elbow fittings 400 on FIGS. 4A through 4E herein, or other types of fittings according to design requirements.

FIGS. 3A through 3D illustrate an embodiment of improved elbow fitting 300 in accordance with this disclosure. FIG. 3A is a general isometric illustration of elbow fitting 300. FIGS. 3B, 3C and 3D are sections as shown on FIG. 3A. Elbow fitting 300 on FIG. 3A is an exemplary 90-degree elbow fitting embodiment, although, as noted below, the scope of this disclosure is not limited in this regard. Referring first to FIGS. 3B and 3C, elbow fitting 300 includes elbow body 306. Elbow body 306 has internal flow path 307 formed therein such that inlet 301A is in fluid communication with outlet 301B via flow path 307. Flange 302A and flange face 302B are provided on each of inlet and outlet 301A, 301B respectively for flanged engagement with neighboring fittings. It will be understood that flange 302A and flange face 302B are exemplary, and that the scope of this disclosure is not limited to the manner in which inlet and outlet 301A, 301B are connected to neighboring fittings.

With further reference to FIG. 2C, elbow fitting 300 will be seen to be analogous to prior art elbow 100 on FIGS. 1A and 1B, in that elbow fitting 300 is derived from a “tee” fitting. The base of the tee is used as outlet 301B, one of the laterals of the tee is used as an inlet 301A, and the other lateral of the tee is sealed off with removable cover 303. FIG. 3C shows that elbow body 306 further includes internal enclosed portion 305 formed therein such that enclosed portion 305 is in fluid communication with enlarged chamber 304 and where enclosed portion 305 generally opposes inlet 301A. Enclosed portion 305 on FIGS. 3A through 3D is enclosed at least in part by removable cover 303. Enclosed portion 305 is similar to cavity portion 105 on prior art elbow 100 on FIG. 1B. Analogous to prior art elbow 100 as described in the “Background” section above, therefore, elbow fitting 300 is able to deviate or “bounce” faster-moving non-Newtonian fluids (such as certain fracking fluids, for example) off slow-moving fluids in enclosed portion 305, thereby assisting the faster-moving fluids to “turn the corner” from inlet 301A to outlet 301B.

It will be seen on FIG. 3C that removable cover 303 forms part of enclosed portion 305 on elbow fitting 300. Removal of removable cover 303 facilitates internal cleanout and inspection of elbow fitting 300 during maintenance.

FIGS. 3B, 3C and 3D further depict internal flow path 307 further including enlarged chamber 304 also formed within elbow body 306. In illustrated embodiments, enlarged chamber 304 is a generally spherically shaped, fashioned using a spherical cutting tool to machine out the interior of elbow fitting 300. It will nonetheless be understood that the scope of this disclosure is not limited to enlarged chamber 304 being a generally spherically shaped chamber. The spherically shaped machining on embodiments of elbow fitting 300 illustrated on FIGS. 3A through 3D may be by any suitable method, such as milling, broaching drilling and/or reaming (just by way of example). A machining technique to create internal enlarged chamber 304 using a spherical cutting tool may be advantageous when elbow fitting 300 is desired to be manufactured from a forging, for example, as opposed to a casting. A casting may be cast from a mold that includes an internal curved sweep such as inside turn curvature 410 as illustrated on FIG. 4C. Machining such an internal curved sweep on a forging is particularly challenging, especially on large diameter elbow fittings providing 90 degrees (or thereabouts) of turn.

Enlarged chamber 304, such as on embodiments of elbow fitting 300 on FIGS. 3A to 3D, provides advantages as an alternative to a more traditional internal curved sweep. First, FIG. 3C shows that enlarged chamber 304 provides transition 306 on the “inside turn” from inlet 301A to outlet 301B. While not an internal curved sweep in the style of inside turn curvature 410 on FIG. 4C, transition 306 on FIG. 3C is effective to allow fluid to “turn the corner” from inlet 301A to outlet 301B without significantly impeding overall fluid flow velocity.

Compare FIG. 3C to FIG. 1B, in which no corresponding transition is provided in prior art elbow fitting 100. Refer now to FIG. 7 of U.S. provisional patent application 63/036,726 (“63/036,726—7”) and compare to FIG. 5B of U.S. provisional patent application 62/859,255 (“62/859,255—5B”). 63/036,726—7 and 62/859,255—5B are both computational fluid dynamics (CFD) diagrams calibrated by color to show fluid flow velocities at a given moment. 63/036,726—7 shows flow velocity patterns for elbow fitting 300 with transition 306 per FIG. 3C. 62/859,255—5B shows corresponding flow velocity patterns for prior art elbow fitting 100 without any transition per FIG. 1B. Comparing 63/036,726—7 and 62/859,255—5B, it will be seen that transition 306 on elbow fitting 300 promotes significantly improved fluid flow velocity “around the corner” from inlet 301A to outlet 301B.

Specific transitions 306 and their corresponding internal spherical curvatures may be customized according to design requirements of a particular elbow fitting 300. Parameters such as internal fluid pressure retention, fluid flow velocity, fluid flow volume, acceptable internal wear and fitting weight may all affect, individually or in combination, selection of specific transitions 306 and associated internal curvatures in view of the chemistry and solids content of the fluid to be delivered. Extensive experimentation and engineering analysis may be required to select a transition 306 and associated internal curvatures that will (1) optimize fluid flow through a particular elbow fitting 300, and/or (2) create low attack angles of fluid flow on interior walls of elbow fitting 300 so as to optimize wear life in view of fluid abrasiveness or corrosiveness.

It will be further appreciated that enlarged chamber 304, such as on embodiments of elbow fitting 300 on FIGS. 3A through 3D, also inherently creates a local pocket of reduced fluid flow velocity within elbow fitting 300. That is, enlarged chamber 304 provides a local pocket of increased fluid volume within elbow fitting 300, causing corresponding slower fluid flow velocity within and through enlarged chamber 304. Stated more generally, when fluid is caused to flow along flow path 307 from inlet 301A to outlet 301B and enters enlarged chamber 304 flowing at a first fluid velocity, fluid flows through enlarged chamber 304 towards outlet 301B at a second fluid velocity such that the second fluid velocity is less than the first fluid velocity. This effect can be seen clearly on 63/036, 726—7, which shows faster flow velocity in the regions of inlet 301A and 301B, and slower flow velocity in enlarged chamber 304. Enlarged chamber 304 is thus less susceptible to internal wall erosion as a result of fluid flow. The reduced fluid flow velocity through enlarged chamber 304 reduces the general potential for fluid flow erosion within enlarged chamber 304. In some deployments, the reduced fluid flow velocity through enlarged chamber 304 may also reduce the potential for localized erosion where the general spherical shape promotes flow patterns that distribute fluid flow more evenly around the internal spherical wall.

63/036,726—7 further shows that, notwithstanding slower fluid flow velocity through enlarged chamber 304, elbow fitting 300 is still well able to deviate or “bounce” faster-moving non-Newtonian fluids (such as certain fracking fluids, for example) off slow-moving fluids in enclosed portion 305, thereby assisting the faster-moving fluids to “turn the corner” from inlet 301A to outlet 301B. Stated more generally, FIG. 7 further shows that when fluid is caused to flow along flow path 307 from inlet 301A to outlet 301B and enters enlarged chamber 304 flowing at a first fluid velocity, fluid flows through enlarged chamber 304 towards outlet 301B at a second fluid velocity such that the second fluid velocity is less than the first fluid velocity. Further, a pocket of slow-moving fluid forms in enclosed portion 305 as fluid flows through enlarged chamber 304 such that the slow-moving fluid in enclosed portion 305 flows at less than the second fluid velocity.

Moreover, 63/036,726—7 shows the regions of highest flow velocity are immediately after flow exit from enlarged chamber 304, where flanges and piping may be found. Enlarged chamber 304 has thus diverted the regions of fluid flow velocity having highest potential for wall erosion outside of elbow fitting 300. This is cost-advantageous since highly-engineered fittings such as elbow fittings 300 are much more expensive to repair or replace than conventional fittings such as flanges and pipe.

It will be further appreciated that enlarged chamber 304 on elbow fitting 300 is not limited to any specific radius of internal spherical curvature. The scope of this disclosure is not limited in regard to radius of curvature on the chamber. Additionally, other embodiments of elbow fitting 300 may provide a chamber in the flow path between inlet 301A and outlet 301B whose internal shape is formed into something other than a generally spherical shape. The scope of this disclosure is also not limited in regard to internal shape of chamber.

It will be further appreciated that embodiments of elbow fitting 300 on FIGS. 3A through 3D have been illustrated with flow path 307 subtending 90-degree turn angle between inlet 301A and outlet 301B (i.e., more colloquially, a “90-degree elbow fitting”). The scope of this disclosure, however, is not limited to such illustrated 90-degree embodiments. The scope includes embodiments of elbow fitting 300 whose internal flow paths may subtend turn angles other than 90 degrees.

As noted above, elbow fitting 300 on FIGS. 3A through 3D is a forging in currently preferred embodiments. In other embodiments, elbow fitting 300 may be a casting. The scope of this disclosure is not limited to the metalworking process from which elbow fitting 300 is formed. Further, currently preferred embodiments of elbow fitting 300 are designed with a nominal internal inlet/outlet diameter of 7′ and a maximum operating internal pressure rating of 15,000 psi (15 ksi). Finite element analysis of elbow fitting 300 embodiments such as shown on FIGS. 3A through 6B of 63/036,726, for example, are predicated on this currently preferred 15 ksi pressure rating×1.5 factor of safety. The scope of this disclosure is not limited, however, to any specific internal inlet/outlet diameter, maximum operating internal pressure rating, minimum or maximum volumetric fluid throughput rating, or maximum fluid flow velocity rating to which elbow fitting 300 may be designed.

Elbow fitting 300 design on FIGS. 3A through 3D further improves upon prior art elbow 100 design on FIGS. 1A and 1B in at least the following ways:

### Reduced Overall Weight of Elbow Fitting while Still Meeting Design Requirements for Internal Pressure Retention

Elbow fitting 300 on FIGS. 3A through 3D of this disclosure further improves upon prior art elbow fitting 100 on FIGS. 1A and 1B by reducing fitting weight while still meeting design requirements for parameters such as internal fluid pressure retention. Lower fitting weight is particularly advantageous in cantilevered boom deployments for elbow fitting 300, examples of which are described in the Related Application. It will be appreciated that a cantilevered boom deployment will be more agile and require less of its positioning motors when it weighs less. Further, the overall bending moments placed on connections near the boom turret will be substantially reduced.

### Optional Internal Wear Protection

As noted above, fluid delivery applications in which the fluid includes suspended solids (as often seen in fracking operations) will show greater propensity for internal wear. Internal wear will be particularly expected in internal zones of high fluid flow velocity, especially where the attack angle of the flow against the internal wall is critically close to inducing erosion. In some embodiments, improved elbow fittings as described in this disclosure may provide internal wear inserts or wear coatings to remediate fluid flow wear on the internal walls of the elbow fittings. Examples of such wear protection are illustrated and described with reference to FIG. 5 in this disclosure and in U.S. provisional patent application Ser. No. 62/859,255, the entire disclosure of which provisional application is incorporated herein by reference.

### Selective Wall Thickness Enhancement to Remediate Localized Tensile Stress

As noted above, elbow fitting 300 on FIGS. 3A through 3D further improves upon prior art elbow 100 on FIGS. 1A and 1B by reducing fitting weight while still meeting design requirements for parameters such as internal fluid pressure retention. Lower fitting weight is particularly advantageous in cantilevered boom deployments for elbow fitting 300, examples of which are described in the Related Application. Reducing fitting weight, however, potentially exposes vulnerable regions of elbow fitting 300's surface to high tensile stresses when elbow fitting 300 is called upon to retain internal pressures tending towards the maximum internal pressures for which elbow fitting 300 is rated.

FIGS. 3A through 6B of U.S. provisional patent application 63/036,726 (“63/036,726—3A through —6B”) illustrate Finite Element Analysis of embodiments of elbow fitting 300 on FIGS. 3A through 3D having a nominal inlet/outlet internal flange diameter of 7″ and wall thickness at no point less than 1.5″. The FEA illustrates tensile stresses on elbow fitting 300 at 22,500 psi internal pressure (internal working pressure rating of 15,000 psi×1.5 factor of safety). Dark orange to red colors on 63/036,726—3A through —6B indicate potential unacceptable conditions with such colors calibrated to show regions whose tensile stress is close to or past steel yield strength. 63/036,726—3A through —6B show no unacceptable conditions with dark orange or red colors substantially all the way through an entire wall thickness in a particular region. Selective wall thickness enhancement in this design/embodiment of elbow fitting 300 is thus likely unnecessary.

That said, other designs may benefit from wall thickness enhancement in selected regions of elbow body 306, particularly where FEA may so indicate. For example, other embodiments or designs of elbow fitting 300 may provide thinner wall thicknesses in order to reduce overall fitting weight yet further. Such other embodiments or designs might benefit from localized wall thickness enhancement where FEA indicated regions of the thinner wall thickness are at or approaching steel yield strength all the way through the wall. One such example is described below with reference to FIGS. 4D and 4E, and to FIGS. 7A and 7B of U.S. provisional patent application 62/859,255.

### FEA and CFD Supporting Serviceability of Elbow Fitting 300

FIGS. 3A through 6B of U.S. provisional patent application 63/036,726 (“63/036,726-3A through —6B”) illustrate Finite Element Analysis of elbow fitting 300 from FIGS. 3A through 3D. The entire disclosure of 63/036,726 is incorporated herein by reference. Part numbers on 63/036,726—3A through —6B correspond to and indicate the same parts described above with reference to FIGS. 3A through 3D.

As noted above in this disclosure, the FEA on 63/036,726—3A through —6B covers embodiments of elbow fitting 300 on FIGS. 3A through 3D having a nominal inlet/outlet internal flange diameter of 7″ and wall thickness at no point less than 1.5″. The FEA illustrates tensile stresses on elbow fitting 300 at 22,500 psi internal pressure (internal working pressure rating of 15,000 psi×1.5 factor of safety). Dark orange to red colors on 63/036,726—3A through —6B indicate potentially unacceptable conditions. 63/036,726—3A through —6B show no potentially unacceptable conditions.

63/036,726—3A and —3B are von Mises diagrams showing nodal stresses calculated on a conventional triangular element grid. Colors are calibrated to show calculated tensile stresses in ksi per the scale, with dark orange and red denoting tensile stresses approaching and exceeding steel yield strength. 63/036,726—3A is a diagram through a section of elbow fitting 300 so that internal tensile stresses may be displayed. 63/036,726—3B is an elevation view of elbow fitting 300 so that exterior tensile stresses may be displayed. 63/036,726—3A and —3B linearize calculated tensile stresses across the local wall thickness and then compare linearized results to published standards for the steel. The resulting comparison enables interior and exterior stresses to be plotted separately, as seen on 63/036,726—3A and —3B. 63/036,726—3A and —3B show no unacceptable conditions with dark orange or red colors substantially all the way through an entire wall thickness in a particular region.

63/036,726—4A and —4B are URES diagrams showing physical displacements (deflections) corresponding to tensile stresses calculated and plotted on 63/036,726—3A and —3B. 63/036,726—4A is a diagram through a section of elbow fitting 300 so that internal displacements may be displayed. 63/036,726—4B is an elevation view of elbow fitting 300 so that exterior displacements may be displayed. Colors are calibrated to show calculated deflections in mm per the scale. 63/036,726—4A and —4B correct for background displacements by assigning, for illustration purposes, a baseline displacement to the darkest blue color.

63/036,726—5A and —5B are ESTRN diagrams showing strains corresponding to tensile stresses calculated and plotted on 63/036,726—3A and —3B. 63/036,726—5A is a diagram through a section of elbow fitting 300 so that internal strains may be displayed. FIG. 5B is an elevation view of elbow fitting 300 so that exterior strains may be displayed. Strains on 63/036,726—5A and —5B are calculated from tensile stresses calculated and plotted on 63/036,726—3A and —3B using conventional engineering theory based on Modulus of Elasticity for the steel. Colors on 63/036,726—5A and —5B are calibrated to show calculated strains per the scale. 63/036,726—5A and —5B correct for background strains by assigning, for illustration purposes, a baseline strain to the darkest blue color.

63/036,726—6A and —6B are “factor of safety” plots in which tensile stresses calculated and plotted on 63/036,726—3A and —3B are filtered according to the stress capability of the steel. 63/036,726—6A is a diagram through a section of elbow fitting 300 so that internal tensile stresses may be displayed. 63/036,726—6B is an elevation view of elbow fitting 300 so that exterior tensile stresses may be displayed. There is no color gradient on 63/036,726—6A and —6B. Any plotted tensile stress below steel yield strength is colorized to blue. Any plotted tensile stress above steel yield strength is colorized to red. Again, as in 63/036,726—3A and —3B, 63/036,726—6A and —6B show no unacceptable conditions with red color substantially all the way through an entire wall thickness in a particular region.

63/036,726—7 illustrates Computational Fluid Dynamics (CFD) analysis of elbow fitting 300 from FIGS. 3A through 3D. Part numbers on 63/036,726—7 correspond to and indicate the same parts described above with reference to FIGS. 3A through 3D. The CFD on 63/036,726−7 plots expected peak fluid flow velocities at a typical internal working pressure. 63/036,726—7 illustrates fluid velocity distributions on and around elbow fitting 300 at nominal fluid delivery volume of 130 bbl/min at 12,000 psi internal pressure.

Colors on 63/036,726—7 are calibrated to show calculated fluid velocities in feet/sec per the scale, with dark orange and red denoting fluid velocities calculated/expected to impart surface stresses that may cause internal wall erosion. A primary goal in the CFD analysis is to recognize high peak fluid velocities at critical attack angles (or “approach angles”). Identification of critical attack angles is a complex analysis simulating when fluid flow is cutting or eroding an internal wall surface rather than bouncing off it (or merely flowing past it). However, empirical testing and observation has identified about 53 feet/sec as a good benchmark above which cutting or erosion may start to occur, depending on attack angle. 63/036,726—7 is calibrated to plot fluid velocities approaching and above about 53 feet/sec in dark orange and red.

Note also that the CFD analysis represented on 63/036,726—7 is based on water as the fluid in order to simplify the representation. The CFD analysis gets more complex with a fracking fluid in which solids (“proppant”) are typically suspended and in which the base fluid is not necessarily plain water. The fluid portion of fracking fluid is typically a mix of chemicals and water.

For example, the fracking fluid may provide a sand-based proppant including a blend of sharp-edged particles and ball-shaped particles. An exemplary proppant of this variety may provide 15% sharp-edged particles by volume, and 85% ball-shaped. Identification of critical attack angles for cutting or erosion of internal wall becomes more complex when proppant is suspended in the fluid. The proportion of sharp-edged particles to ball-shaped particles also affects attack angle analysis.

The CFD analysis on 63/036,726—7 thus serves as a baseline to identify regions where fluid velocities are expected to approach or exceed 53 feet/sec with plain water. Attack angle analysis in view of proppant content and fluid content, for example, can proceed from this baseline in order to identify regions of concern for fluid flow erosion.

FIGS. 4A, 4B and 4C illustrate an embodiment of improved elbow fitting 400. FIGS. 4A and 4B are isometric and elevation views of elbow fitting 400 respectively, and FIG. 4C is a section view as shown on FIG. 4A. Elbow fitting 400 on FIGS. 4A through 4C is an exemplary 90-degree elbow fitting embodiment, although, as noted below, the scope of this disclosure is not limited in this regard. Elbow fitting 400 embodies improvements over prior art elbow fittings discussed in the “Background” section above. Referring first to FIGS. 4A and 4B, elbow fitting 400 includes inlet 401A and outlet 401B. External threads 402 are provided on each of inlet and outlet 401A, 401B for engagement with neighboring fittings such as threaded unions or the like. It will be understood that external threads 402 are exemplary, and that the scope of this disclosure is not limited to the manner in which inlet and outlet 401A, 401B are connected to neighboring fittings.

With further reference to FIG. 4B, elbow fitting 400 will be seen to be analogous to prior art elbow 100 on FIGS. 1A and 1B, in that elbow fitting 400 is derived from a “tee” fitting. The base of the tee is used as outlet 401B, one of the laterals of the tee is used as an inlet 401A, and the other lateral of the tee is sealed off with removable cover 403. FIG. 4C shows that elbow fitting 400 provides flow path portion 404 and cavity portion 405 similar to flow path portion and cavity portion 104, 105 on prior art elbow 100 on FIG. 1B. Elbow fitting 400 on FIG. 4C includes elbow body 406. Elbow body 406 has internal flow path 407 formed therein such that inlet 401A is in fluid communication with outlet 401B via flow path 407. Further, FIG. 4C shows that elbow body 306 further includes internal cavity portion 405 formed therein such that cavity portion 405 is in fluid communication with flow path portion 404 and where cavity portion 405 generally opposes inlet 401A. Cavity portion 405 on FIGS. 4A through 4C is enclosed at least in part by removable cover 403. Cavity portion 405 is similar to cavity portion 105 on prior art elbow 100 on FIG. 1B. Analogous to prior art elbow 100 as described in the “Background” section above, therefore, elbow fitting 400 is able to deviate or “bounce” faster-moving non-Newtonian fluids in flow path portion 404 (such as certain fracking fluids, for example) off slower-moving fluids in cavity portion 405, thereby assisting the faster-moving fluids to “turn the corner” from inlet 401A to outlet 401B. Stated more generally, when fluid is caused to flow along flow path 407 from inlet 401A to outlet 401B and enters inlet 401A flowing at a first fluid velocity, a pocket of slow-moving fluid forms in cavity portion 405 such that the slow-moving fluid in cavity portion 405 flows at less than the first fluid velocity.

It will be seen on FIGS. 4B and 4C that removable cover 403 forms part of cavity portion 405 on elbow fitting 400. Removal of removable cover 403 facilitates internal cleanout and inspection of elbow fitting 400 during maintenance. FIGS. 4A, 4B and 4C also depict lifting lugs 409 on elbow fitting 400 to assist with positioning elbow fitting 400 during deployments.

FIG. 4C further depicts elbow fitting 400 providing inside turn curvature 410. Inside turn curvature 410 on elbow fitting 400 allows fast-moving solids and fluids in flow path portion 404 to move from inlet 401A to outlet 401B while optimizing loss of flow velocity as fluid and particles “turn the corner”.

Specific inside turn curvatures 410 are customized according to design requirements of a particular elbow fitting 400. Parameters such as internal fluid pressure retention, fluid flow velocity, fluid flow volume, acceptable internal wear and fitting weight may all affect, individually or in combination, selection of specific inside turn curvatures 410 in view of the chemistry and solids content of the fluid to be delivered. Extensive experimentation and engineering analysis may be required to select an inside turn curvature 410 that will (1) optimize fluid flow through a particular elbow fitting 400, and/or (2) create low attack angles of fluid flow on interior walls of elbow fitting 400 so as to optimize wear life in view of fluid abrasiveness or corrosiveness.

It will be further appreciated that embodiments of elbow fitting 400 on FIGS. 4A through 4C have been illustrated with flow path 407 subtending 90-degree turn angle between inlet 401A and outlet 401B (i.e., more colloquially, a “90-degree elbow fitting”). The scope of this disclosure, however, is not limited to such illustrated 90-degree embodiments. The scope includes embodiments of elbow fitting 300 whose internal flow paths may subtend turn angles other than 90 degrees.

Elbow fitting 400 on FIGS. 4A through 4C is a casting in currently preferred embodiments. In other embodiments, elbow fitting 400 may be a forging. The scope of this disclosure is not limited to the metalworking process from which elbow fitting 400 is formed. Further, currently preferred embodiments of elbow fitting 400 are designed with a nominal internal inlet/outlet diameter of 7′ and a maximum operating internal pressure rating of 15,000 psi (15 ksi). Finite element analysis of elbow fitting 400 embodiments such as shown on FIGS. 7A and 7B of 62/859,255, for example, are predicated on this currently preferred 15 ksi pressure rating×1.5 factor of safety. The scope of this disclosure is not limited, however, to any specific internal inlet/outlet diameter, maximum operating internal pressure rating, minimum or maximum volumetric fluid throughput rating, or maximum fluid flow velocity rating to which elbow fitting 400 may be designed.

Elbow fitting 400 design on FIGS. 4A through 4C thus improves upon prior art elbow 100 design on FIGS. 1A and 1B in at least the following ways:

### Improved Fluid Flow Velocity Improved Fluid Flow Consistency and Reduced Expected Internal Wear

FIGS. 4A and 4B of 62/859,255 (“62/859,255—4A and —4B”) are computational fluid dynamics (CFD) diagrams of exemplary fluid flow through a 90-degree embodiment of elbow fitting 300 as labeled on 62/859,255—4A and —4B. Items 300, 301A, 301B, 303, 304 and 305 on 62/859,255—4A and —4B correspond to items 400, 401A, 401B, 403, 404 and 405 respectively on FIGS. 4A through 4C of this disclosure. 462/859,255—4A and —4B are colorized to show exemplary fluid flow velocities at a given moment according to the color scale on the Figures. 62/859,255—4A depicts fluid flow velocities for individual flow vectors through elbow fitting 400 from FIGS. 4A through 4C. 62/859,255—4B depicts fluid flow velocities in more of a flow pattern through two consecutive elbow fittings 400. With momentary reference to 62/859,255—1D, prior art elbow fitting 100 shows substantial loss of fluid flow velocity on the inside turn as fluid flow “turns the corner” from inlet 101A to outlet 101B. In contrast, 62/859,255—4A and —4B show that inside turn curvatures 410 on elbow fittings 400 promote smooth and rapid fluid flow near inside turn curvatures 410 as fluid flow “turns the corner” inside elbow fittings 400.

62/859,255—4A and —4B further show that flow is a slow-moving vortex in cavity portions 405 of elbow fittings 400. Especially in applications such as in fracking fluids having non-Newtonian flow characteristics, fluid flow in flow path portions 404 may deviate or “bounce” off the slow-moving fluid in cavity portions 405 to further assist smooth “turning the corner” without substantial loss in fluid flow velocity. 62/859,255—4A and —4B depict such smooth flow through flow path portions 404 without substantial flow velocity loss.

62/859,255—1D also illustrates fluid flow velocities before and after fluid passes through prior art elbow fitting 100. 62/859,255—1D shows the “before and after” flow velocities to be highly inconsistent. Comparing now with corresponding fluid flow velocities before and after fluid passes through elbow fittings 400, 62/859,255—4A and —4B further depict such “before and after” velocities as highly consistent. This means that unlike in prior art elbow fitting 100, fluid flow does not lose a significant amount of overall velocity as it passes through elbow fittings 400.

FIGS. 5A, 5B and 5C of 62/859,255 (“62/859,255—5A, —5B and —5C”) further contrast fluid flow velocity consistencies between prior art elbow fitting 100 embodiments and improved elbow fitting 400 embodiments. 62/859,255—5A, —5B and —5C are CFD diagrams that make this contrast over a sequential series of fittings. Item 400 on 62/859,255—5A is an exemplary deployment of multiple sequential prior art elbow fittings 100 as described above with reference to FIGS. 1A and 1B of this disclosure. 62/859,255—5B is an enlargement as shown on 62/859,255—5A. 62/859,255—5A and —5B are colorized to show exemplary fluid flow velocities at a given moment according to the color scale on the Figures. 62/859,255—5B shows that some fluid flow vectors lose substantial velocity as flow “turns the corner” in prior art elbow 100. Fluid flow velocities are also inconsistent before and after passing though prior art elbow 100. 62/859,255—5A illustrates how loss of fluid flow velocity and fluid flow consistency over a series of elbows 100 affects overall fluid delivery in the depicted exemplary deployment.

By contrast, 62/859,255—5C is a CFD diagram of an exemplary deployment 500 of multiple sequential improved elbow fittings 400 from FIGS. 4A, 4B and 4C in this disclosure. Exemplary deployment 500 on 62/859,255—5C is consistent with analogous embodiments described in the Related Application. Elbow fittings 300 on 62/859,255—5C are 90-degree embodiments corresponding to elbow fittings 400 as described above in this disclosure with reference to FIGS. 4A, 4B and 4C. Elbow fitting 350 on 62/859,255—5C is a non-90 degree embodiment that is analogous in all respects to elbow fitting 400 on FIGS. 4A through 4C of this disclosure, except that flow deviates less than 90 degrees through elbow fitting 350 instead of 90 degrees. FIG. 5 of this disclosure and associated text below discuss embodiments of non-90 degree elbow fitting 350 in more detail. 62/859,255—5C is colorized to show exemplary fluid flow velocities at a given moment according to the scale on the Figure. 62/859,255—5C illustrates fluid flow maintaining flow velocity and flow consistency over an extended series of elbow fittings 400 (300) on exemplary deployment 500. Improved fluid flow velocity and improved fluid flow consistency over a series of elbow fittings 400 (300) such as depicted on 62/859,255—5C translates into improved fluid delivery volume. As has been previously noted, improved fluid delivery volume is particularly advantageous to enhance fracking fluid delivery systems such as are described in the Related Application.

62/859,255—4A, —4B, —5A, —5B and —5C further illustrate a reduced expectation of internal wear as a result of improved fluid flow consistency. It will be appreciated that fluid delivery will show greater propensity for internal wear in applications in which the fluid includes suspended solids (“proppant”, as often seen in fracking operations). Internal wear will be particularly expected in zones of high fluid flow velocity, especially where the attack angle of the flow against the internal wall is high. Referring momentarily to 62/859,255—1D, prior art elbow fitting 100 exhibits high flow velocity immediately before the inside turn, and immediately after the outside turn. The attack angle immediately after the outside turn will be further understood to be high. High internal wear may be expected in both these regions, and particularly after the outside turn.

In contrast, 62/859,255—4B and 62/859,255—5C illustrate that elbow fitting 400 embodiment from FIGS. 4A through 4C in this disclosure exhibits high flow velocity immediately before the inside turn, but lower flow velocity immediately after the outside turn. Reduced wear may therefore be expected immediately after the outside turn as compared to prior art elbow 100 on 62/859,255—1D. Further, although elbow fitting 400 (300) on 62/859,255—4A and 62/859,255—5C exhibits high flow velocity immediately before the inside turn, the attack angle in this region is very low. Thus, wear in this region on elbow fitting 400 may be expected to be at least comparable to wear at the inside turn on prior art elbow fitting 100, and possibly lower given the favorable progressing attack angles created by inside turn curvature 410 on elbow fitting 400 (refer FIG. 4C of this disclosure).

### Reduced Overall Weight of Elbow Fitting while Still Meeting Design Requirements for Internal Pressure Retention

Elbow fitting 400 on FIGS. 4A through 4C of this disclosure further improves upon prior art elbow fitting 100 on FIGS. 1A and 1B by reducing fitting weight while still meeting design requirements for parameters such as internal fluid pressure retention. Lower fitting weight is particularly advantageous in cantilevered boom deployments for elbow fitting 400, examples of which are described in the Related Application. It will be appreciated that a cantilevered boom deployment will be more agile and require less of its positioning motors when it weighs less. Further, the overall bending moments placed on connections near the boom turret will be substantially reduced.

Physical embodiments consistent with prior art elbow fitting 100 and elbow fitting 400 described herein have the following comparative performance specifications:

Internal working pressure rating for both: 7,000 psi-20,000 psi, nominally 15,000 psi (burst pressure less than 23,000 psi with 1.5 factor of safety during testing on nominal 15,000 psi internal working pressure rating).

Flow rate capability for both: 70 bbl/min-130 bbl/min (49.2 gal/sec-91.2 gal/sec)

Dead weight: Prior art elbow fitting 100=2263 lbs vs. elbow fitting 400=568 lbs

In the foregoing example, embodiments of elbow fitting 400 weigh approximately 75% less than corresponding embodiments of prior art elbow 100 where both fittings are capable of retaining comparable internal pressures and are capable of delivering comparable flow rates. It will be appreciated that such a substantial individual fitting weight reduction will aggregate quickly to yield a significant overall fitting weight reduction in cantilevered boom deployments such as are described in the Related Application.

### Optional Internal Wear Protection

As noted above, fluid delivery applications in which the fluid includes suspended solids (“proppant”, as often seen in fracking operations) will show greater propensity for internal wear. Internal wear will be particularly expected in internal zones of high fluid flow velocity, especially where the attack angle of the flow against the internal wall is critically close to inducing erosion. In some embodiments, improved elbow fittings as described in this disclosure may provide internal wear inserts or wear coatings to remediate fluid flow wear on the internal walls of the elbow fittings. Examples of such wear protection are illustrated and described both in this disclosure and in U.S. provisional patent application Ser. No. 62/859,255, the entire disclosure of which provisional application is incorporated herein by reference.

FIGS. 6A, 6B and 6C of 62/859,255 (“62/859,255—6A, —6B and —6C”) illustrate a first exemplary embodiment of wear insert 600 deployed on non-90 degree elbow fitting 350. FIG. 5 of this disclosure is substantially the same as 62/859,255—6B. Although improvements have been described thus far in this disclosure with reference to 90-degree elbow fitting 400 embodiment as shown on FIG. 4C of this disclosure, for example, the scope of this disclosure is not limited in this regard. Other elbow fitting embodiments may also display improvements consistent with the scope of this disclosure, such as, for example, non-90 degree elbow fitting 350 embodiment as shown on FIG. 5 and 62/859,255—6A through —6C. Non-90 degree elbow fitting 350 has, in preferred embodiments, a deviation of about 30 degrees, although again the scope of this disclosure is no limited in this regard.

62/859,255—6A depicts elbow fitting 350 embodiment in section without wear insert 600. Elbow fitting 350 includes inlet 351A, outlet 351B, flanged cover 353, flow path portion 354 and cavity portion 355. It will be appreciated by comparing 62/859,255—6A to FIG. 4C in this disclosure that non-90 degree elbow fitting 350 on 62/859,255—6A is analogous to 90-degree elbow fitting 400 on FIG. 4C, and that description above of elbow fitting 400 is also applicable to elbow fitting 350.

FIG. 5 of this disclosure and 62/859,255—6B illustrate non-90 degree elbow fitting 350 in section with wear insert 600 attached internally. Wear insert 600 is an exemplary embodiment thereof, and the scope of this disclosure is not limited to the illustrated embodiments of wear inserts or wear coatings. As also seen on 62/859,255—6C, wear insert 600 is advantageously shaped to be received inside elbow fitting 350, and is sized to protect the internal wall of elbow fitting 350 over an internal surface extending from inlet 351A to outlet 351B to flanged cover 353. Other embodiments of wear insert 600 may be sized and positioned to protect smaller, targeted areas of the internal wall of elbow fitting 350. The scope of this disclosure is not limited in this regard.

Preferably, wear insert 600 is internally smooth or seamless in order to promote smooth, laminar fluid flow through elbow fitting 350 without creating unnecessary turbulence. Preferably, the wall thickness of elbow fitting 350 is adjusted to accommodate the thickness of wear insert 600 so as not to constrict the overall internal fluid flow diameter in elbow fitting 350. In this way, elbow fitting 350's potential fluid flow throughput capability is not reduced by adding wear insert 600's thickness to an unadjusted wall thickness of elbow fitting 350.

In embodiments illustrated on FIG. 5 and 62/859,255—6A through —6C, wear insert 600 may be a sleeve or insert made from steel with a wear resistant component such as a high cobalt content. It will be appreciated that such high cobalt content materials will offer increased resistance to abrasion or corrosion. In other embodiments, wear insert 600 may include tungsten carbide content or other wear-resistant or corrosion-resistant content. Again, the scope of this disclosure is not limited in such regards.

In embodiments illustrated on FIG. 5 and 62/859,255—6A through —6C, wear insert 600 may be a sleeve or insert affixed to the internal wall of elbow fitting 350 via welding, for example. The scope of this disclosure is not limited to the manner in which wear insert 600 is affixed to elbow fitting 350. In other embodiments, wear insert 600 may be a coating applied directly to the internal wall of elbow fitting 350 by surface welding, brazing or spraying, for example. Again, the scope of this disclosure is not limited in these regards.

In some embodiments, wear insert 600 may be a hybrid of various sizes, shapes, materials, thicknesses, attachment methods and other variables designed to suit the needs of a particular deployment. The scope of this disclosure is not limited in this regard.

62/859,255—6D illustrates 90-degree elbow fitting 400 embodiment from FIG. 4C in this disclosure providing wear insert 610. Item 300 on 62/859,255—6D corresponds to elbow fitting 400 embodiment on FIG. 4C of this disclosure. Items 301A and 301B on 62/859,255—6D correspond to items 401A and 401B on FIG. 4C respectively. 62/859,255—6D should be compared to FIG. 4C in this disclosure and associated description for reference to 90-degree elbow fitting 400 without wear insert 610. Wear insert 610 on elbow fitting 400 (300) on 62/859,255—6D is analogous to wear insert 600 on elbow fitting 350 on 62/859,255—6A through —6C and on FIG. 5 of this disclosure. Disclosure above describing wear insert 600 on non-90 degree elbow fitting 350 applies equally to wear insert 610 on 90 degree elbow fitting 400 (300) on 62/859,255—6D.

### Selective Wall Thickness Enhancement to Remediate Localized Tensile Stress

As noted above, elbow fitting 400 on FIGS. 4A through 4C further improves upon prior art elbow 100 on FIGS. 1A and 1B by reducing fitting weight while still meeting design requirements for parameters such as internal fluid pressure retention. Lower fitting weight is particularly advantageous in cantilevered boom deployments for elbow fitting 400, examples of which are described in the Related Application. Reducing fitting weight, however, potentially exposes vulnerable regions of elbow fitting 400's surface to high tensile stresses when elbow fitting 400 is called upon to retain internal pressures tending towards the maximum internal pressures for which elbow fitting 400 is rated.

Embodiments of elbow fitting 400 may benefit from wall thickness enhancement in selected regions of elbow body 406, particularly where Finite Element Analysis (FEA) may so indicate. Referring now to 62/859,255 (the entire disclosure of which is incorporated herein by reference), FIG. 7A of 62/859,255 (“62/859,255—7A”) is a FEA diagram illustrating tensile stress regions on an exemplary embodiment of unimproved elbow fitting 700. It will be understood that elbow fitting 700 on 62/859,255—7A is under internal pressure from internal fluid flow. Unimproved elbow fitting 700 has a constant wall thickness throughout, such as may be typically found in a conventional swept elbow. 62/859,255—7A is colorized to show regions of higher tensile stress in red, orange and yellow, and regions of lower tensile stress in green and blue, all according to the scale on the Figure. The color is calibrated so that regions in red have a tensile stress under designated internal fluid pressure loading that exceeds the yield stress of the elbow. 62/859,255—7A depicts of high tensile stress region 710, especially in the “central” region of unimproved elbow fitting 700.

FIG. 7B of 62/859,255 (“62/859,255—7B”) is an FEA diagram illustrating tensile stress regions on an exemplary embodiment of improved elbow fitting 400 as depicted in more detail on FIGS. 4A, 4B and 4C of this disclosure. 62/859,255—7B is colorized and calibrated in the same way as 62/859,255—7A to show regions of higher tensile stress in red, orange and yellow, and regions of lower tensile stress in green and blue. Note that items 300, 301A, 301B and 303 on 62/859,255—7B correspond to items 400, 401A, 40B and 403 on FIGS. 4A, 4B and 4C of this disclosure. It will be understood that elbow fitting 400 (300) on 62/859,255—7B is under comparable internal pressure from internal fluid flow to unimproved elbow fitting 700 on 62/859,255—7A. Improved elbow fitting 400 (300) on 62/859,255—7B has enhanced wall thicknesses as described in more detail below with reference to FIGS. 4D and 4E of this disclosure, where such enhanced wall thicknesses are selectively positioned on elbow fitting 400 to remediate local regions of high tensile stress such as high tensile stress region 710 on 62/859,255—7A. 62/859,255—7B shows elbow fitting 400's (300's) “central” region is relatively free of high tensile stresses as compared to high tensile stress region 710 on unimproved elbow fitting 700 on 62/859,255—7A.

FIGS. 4D and 4E in this disclosure are sections as shown on FIG. 4B, and illustrate exemplary wall thickness enhancements selectively positioned on elbow fitting 400 to remediate local regions of high tensile stress such as high tensile stress region 710 as shown on 62/859,255—7A. Wall thickness enhancements as depicted on FIGS. 4D and 4E enable elbow fitting 400's “central” region to be relatively free of high tensile stresses as illustrated on 62/859,255—7B.

Referring first to FIG. 4D, wall thickness T2 is greater than wall thickness T1 in regions towards inlet 401A. It will be seen that wall thickness T2 corresponds to regions near the outer periphery of the “central” high tensile stress region 710 on 62/859,255—7A. Referring now to FIG. 4E, it will be seen that wall thickness T3 is greater than wall thickness T1 in regions corresponding to the “central” high tensile stress region 710 on 62/859,255—7A. It will be understood that enhanced wall thicknesses T3 and T2 contribute to remediating local regions of high tensile stress while still optimizing overall fitting weight of improved elbow fitting 400.

FIG. 4D also depicts enhanced wall thickness T4 at the inside and outside turns of elbow fitting 400. In embodiments illustrated on FIG. 4D, enhanced wall thickness T4 provides additional wear protection in regions expecting high fluid flow velocity and/or high fluid flow attack angle. Refer above to description associated with 62/859,255—4A and —4B discussing internal wall thickness wear.

It will be appreciated that the wall thickness embodiments illustrated on FIGS. 4D and 4E are examples only. Further, the specific remediation of local tensile stress regions such as high tensile stress region 710 on 62/859,255—7A is also by way of example. The scope of this disclosure is not limited to the examples depicted on 62/859,255—7A and —7B, and on FIGS. 4D and 4E of this disclosure, in regard to remediation of local tensile stress regions via wall thickness enhancement.

It will be appreciated from the description above that disclosed embodiments of elbow fitting 300 on FIGS. 3A through 3D, and of elbow fitting 400 on FIGS. 4A through 4E, are all highly-engineered articles of manufacture. Preferably, high flow, high pressure-rated embodiments of elbow fitting 300/400 in accordance with this disclosure have an internal diameter at inlet 301A/401A of not less than about 7 inches, and provide elbow bodies with ability to retain an internal pressure of not less than about 10,000 psi. It will be appreciated from the scope, depth, complexity and detail of the engineering design described in this disclosure that such high flow, high-pressure rated embodiments are not simple “scale-ups” of smaller and lower pressure-rated fittings. Considerable engineering and analysis is required to result in a serviceable fitting for the required high flow volumes and high pressure ratings.

Although the material in this disclosure has been described in detail along with some of its technical advantages, it will be understood that various changes, substitutions and alternations may be made to the detailed embodiments without departing from the broader spirit and scope of such material as set forth in the following claims.

We claim:

1. An elbow fitting, comprising:
an elbow body, the elbow body having an inlet, an outlet and an internal flow path formed therein such that the inlet is in fluid communication with the outlet via the flow path, wherein the flow path subtends a predetermined turn angle between the inlet and the outlet;
wherein the flow path further includes an enlarged chamber also formed within the elbow body.

2. The elbow fitting of claim 1, in which the elbow body further includes an internal enclosed portion formed therein such that the enclosed portion is in fluid communication with the enlarged chamber and wherein the enclosed portion generally opposes the inlet.

3. The elbow fitting of claim 1, in which the enlarged chamber is generally spherically shaped.

4. The elbow fitting of claim 1, in which the predetermined turn angle is 90 degrees.

5. The elbow fitting of claim 1, in which, when fluid is caused to flow along the flow path from the inlet to the outlet and enters the enlarged chamber flowing at a first fluid velocity, fluid flows through the enlarged chamber towards the outlet at a second fluid velocity such that the second fluid velocity is less than the first fluid velocity.

6. The elbow fitting of claim 5, in which the elbow body further includes an internal enclosed portion formed therein such that the enclosed portion is in fluid communication with the enlarged chamber and wherein the enclosed portion generally opposes the inlet; and
wherein further:
(1) a pocket of slow-moving fluid forms in the enclosed portion as fluid flows through the enlarged chamber; and
(2) the slow-moving fluid in the enclosed portion flows at less than the second fluid velocity.

7. The elbow fitting of claim 2, in which the elbow fitting further includes a removable cover, and in which the enclosed portion is enclosed at least in part by the removable cover.

8. The elbow fitting of claim 1, further comprising wall thickness enhancement in selected regions of the elbow body.

9. An elbow fitting, comprising:
an elbow body, the elbow body having an inlet and an outlet, the elbow body further having an internal flow path and an internal enclosed portion formed therein such that the inlet is in fluid communication with the outlet via the flow path, wherein the flow path subtends a predetermined turn angle between the inlet and the outlet;
wherein the flow path further includes an enlarged chamber also formed within the elbow body;
wherein the enclosed portion is in fluid communication with the enlarged chamber and wherein the enclosed portion generally opposes the inlet.

10. The elbow fitting of claim 9, in which the enlarged chamber is generally spherically shaped.

11. The elbow fitting of claim 9, in which the predetermined turn angle is 90 degrees.

12. The elbow fitting of claim 9, in which, when fluid is caused to flow along the flow path from the inlet to the outlet and enters the enlarged chamber flowing at a first fluid velocity, fluid flows through the enlarged chamber towards the outlet at a second fluid velocity such that the second fluid velocity is less than the first fluid velocity.

13. The elbow fitting of claim 9, in which the elbow fitting further includes a removable cover, and in which the enclosed portion is enclosed at least in part by the removable cover.

14. The elbow fitting of claim 9, in which the elbow fitting is selected from the group consisting of (a) a forging, and (b) a casting.

15. The elbow fitting of claim 9, in which the inlet has an internal diameter of not less than about 7 inches, and in which the elbow body is further capable of retaining an internal pressure of not less than about 10,000 psi.

16. An elbow fitting, comprising:
an elbow body, the elbow body having an inlet and an outlet, the elbow body further having an internal flow path and an internal enclosed portion formed therein such that the inlet is in fluid communication with the outlet via the flow path, wherein the flow path subtends a predetermined turn angle between the inlet and the outlet;
wherein the flow path further includes an enlarged chamber also formed within the elbow body in which the enlarged chamber is generally spherically shaped;
wherein the enclosed portion is in fluid communication with the enlarged chamber and wherein the enclosed portion generally opposes the inlet.

17. The elbow fitting of claim 16, in which the predetermined turn angle is 90 degrees.

18. The elbow fitting of claim 16, in which, when fluid is caused to flow along the flow path from the inlet to the outlet and enters the enlarged chamber flowing at a first fluid velocity, fluid flows through the enlarged chamber towards the outlet at a second fluid velocity such that the second fluid velocity is less than the first fluid velocity.

19. The elbow fitting of claim 18, in which:
(1) a pocket of slow-moving fluid forms in the enclosed portion as fluid flows through the enlarged chamber; and
(2) the slow-moving fluid in the enclosed portion flows at less than the second fluid velocity.

20. The elbow fitting of claim 16, in which the elbow body fitting includes a removable cover, and in which the enclosed portion is enclosed at least in part by the removable cover.
